(19) United States
(12) Patent Application Publication
(10) Pub. No.: US 2004/0040603 A1
(43) Pub. Date: Mar. 4, 2004

(54) Switch valve mounting device of faucet

(76) Inventor: Ming-Chung Shieh, Taichung (TW)

Correspondence Address: Ming-Chung Shieh, 58, MA YUAN WEST ST., TAICHUNG, TW

(21) Appl. No.: 10/232,742

(22) Filed: Aug. 28, 2002

(51) Int. Cl. F17D 1/00

(52) U.S. Cl. 137/597

(57) ABSTRACT

A switch valve mounting device of a faucet includes a four-way valve body, and a switch valve mounted in the four-way valve body. The four-way valve body is provided with a first tubular section for connection to a water outlet head, a second tubular section for connection to a spray hose of a spray head, a third tubular section for connection to a water inlet hose of a cold water control valve, and a fourth tubular section for connection to a water inlet hose of a hot water control valve. Thus, the switch valve is mounted in the inner space of the four-way valve body individually and independently, so that mounting of the switch valve is not limited by the configuration and space of the faucet body.

### BACKGROUND OF THE INVENTION

1. Field of the Invention

The present invention relates to a switch valve mounting device of a faucet, and more particularly to a switch valve mounting device of a faucet, wherein the switch valve is mounted in the inner space of the four-way valve body individually and independently, so that mounting of the switch valve is not limited by the configuration and space of the faucet body.

2. Description of the Related Art

A conventional faucet in accordance with the prior art comprises a water outlet head, a spray head, and a switch valve mounted between the water outlet head and the spray head, so that the water may be selectively output from the water outlet head or the spray head, so as to satisfy the different requirements of the user. The conventional faucet is integrally formed with the cold water inlet connector, the hot water inlet connector, the water outlet head and the spray head. Thus, it is necessary to provide a valve jacket to function as an assembly interface of the switch valve, or the inner space of the faucet body needs to fit the size of the switch valve, so that the switch valve may be mounted in the conventional faucet conveniently. However, the faucet body needs to exactly fit the size of the switch valve, so as to mount the switch valve in the conventional faucet, thereby causing inconvenience in assembly, and thereby increasing the cost of fabrication. In addition, the manufacturer has to make faucets of different types so as to fit switch valves of different sizes, thereby increasing the cost of fabrication, and thereby causing a stock storage problem.

### SUMMARY OF THE INVENTION

The present invention has arisen to mitigate and/or obviate the disadvantage of the conventional faucet.

The primary objective of the present invention is to provide a switch valve mounting device of a faucet, wherein the switch valve is mounted in the inner space of the four-way valve body individually and independently, so that mounting of the switch valve is not limited by the configuration and space of the faucet body.

Another objective of the present invention is to provide a switch valve mounting device of a faucet, wherein the structure of the faucet adopts a separating design.

A further objective of the present invention is to provide a switch valve mounting device of a faucet, wherein by the separating assembly manner, the four-way valve body may co-operate with parts or accessories of different types, thereby enhancing the versatility of the switch valve mounting device of a faucet in accordance with the present invention.

In accordance with the present invention, there is provided a switch valve mounting device of a faucet, comprising a four-way valve body, and a switch valve mounted in the four-way valve body, wherein:

the four-way valve body has an inner wall formed with an inner space for mounting the switch valve;

the four-way valve body has a first portion provided with a first tubular section for connection to a water outlet head, and a second portion provided with a reduced diameter second tubular section which is formed with an outer thread for connection to a spray hose of a spray head; and

the four-way valve body has an outer wall provided with a third tubular section for connection to a water inlet hose of a cold water control valve, and provided with a fourth tubular section for connection to a water inlet hose of a hot water control valve.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a switch valve mounting device of a faucet in accordance with a preferred embodiment of the present invention;

FIG. 2 is a perspective assembly view of the switch valve mounting device of a faucet in accordance with the preferred embodiment of the present invention; and

FIG. 3 is a schematic perspective view of the switch valve mounting device of a faucet.

### DETAILED DESCRIPTION OF THE INVENTION

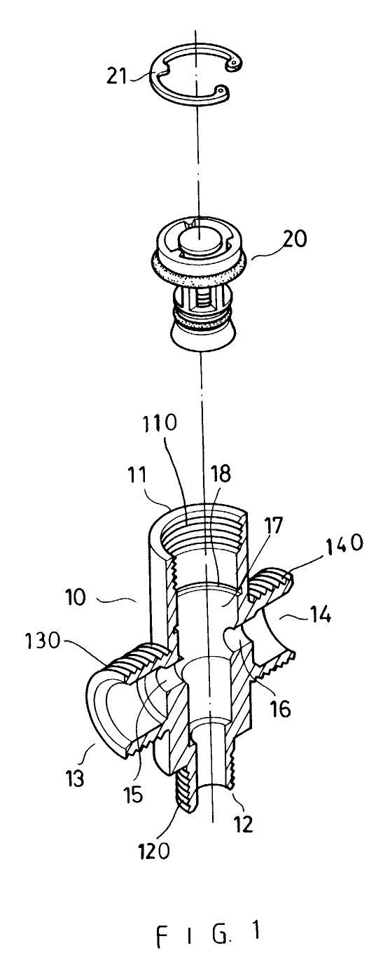

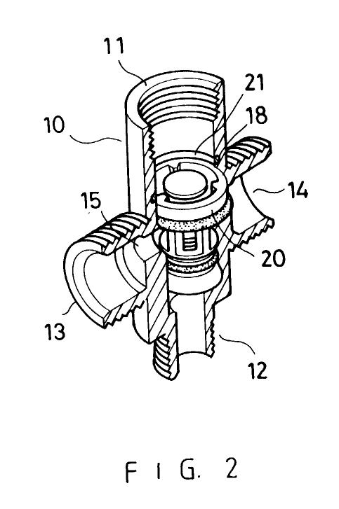

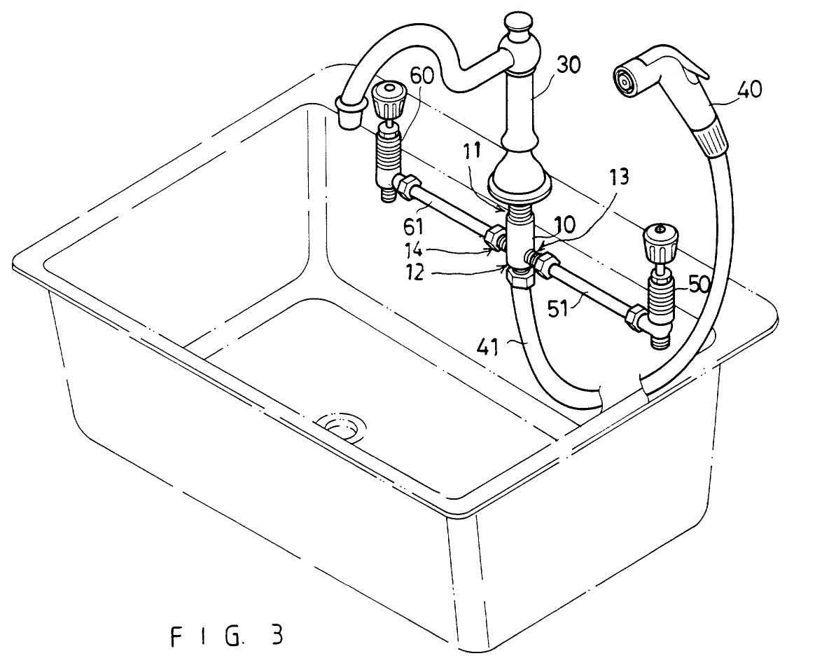

Referring to the drawings and initially to FIGS. 1 and 2 with reference to FIG. 3, a switch valve mounting device of a faucet in accordance with a preferred embodiment of the present invention is shown. In the present invention, the structure of the faucet adopts a separating design.

The switch valve mounting device of a faucet in accordance with the present invention comprises a four-way valve body 10. The four-way valve body 10 has an inner wall formed with an inner space 17 for mounting a switch valve 20.

The four-way valve body 10 has a first portion provided with a first tubular section 11 which is formed with an inner thread 110 for connection to a water outlet head 30 (see FIG. 3), and a second portion provided with a reduced diameter second tubular section 12 which is formed with an outer thread 120 for connection to a spray hose 41 (see FIG. 3) of a spray head 40 (see FIG. 3).

The four-way valve body 10 has an outer wall provided with a third tubular section 13 which is formed with an outer thread 130 for connection to a water inlet hose 51 (see FIG. 3) of a cold water control valve 50 (see FIG. 3), and provided with a fourth tubular section 14 which is formed with an outer thread 140 for connection to a water inlet hose 61 (see FIG. 3) of a hot water control valve 60 (see FIG. 3). The third tubular section 13 of the four-way valve body 10 is formed with a water inlet hole 15 communicating with the inner space 17 of the four-way valve body 10, and the fourth tubular section 14 of the four-way valve body 10 is formed with a water inlet hole 16 communicating with the inner space 17 of the four-way valve body 10.

The inner space 17 of the four-way valve body 10 is designed to fit the size of the switch valve 20, and has an inner edge formed with an annular insertion groove 18 for securing the switch valve 20 in the inner space 17 of the four-way valve body 10 by a C-shaped snap ring 21. Thus, after the switch valve 20 is inserted into the inner space 17 of the four-way valve body 10, the C-shaped snap ring 21 may be inserted into the annular insertion groove 18 of the inner space 17 of the four-way valve body 10, so that the switch valve 20 may be secured in the inner space 17 of the four-way valve body 10 by the C-shaped snap ring 21. In such a manner, the four-way valve body 10 and the switch valve 20 may be assembled individually and independently.

Referring to FIG. 3 with reference to FIGS. 1 and 2, the four-way valve body 10 and the switch valve 20 may be assembled individually and independently, so that mounting of the switch valve 20 is not limited by the configuration and space of the faucet. In addition, in assembly of the faucet, the first tubular section 11 of the four-way valve body 10 is connected to the water outlet head 30, the second tubular section 12 of the four-way valve body 10 is connected to the spray hose 41 of the spray head 40, the third tubular section 13 of the four-way valve body 10 is connected to the water inlet hose 51 of the cold water control valve 50, and the fourth tubular section 14 of the four-way valve body 10 is connected to the water inlet hose 61 of the hot water control valve 60.

In such a manner, the switch valve 20 may be mounted in the four-way valve body 10 individually and independently, and the four-way valve body 10 may be connected to the water outlet head 30, the spray hose 41 of the spray head 40, the water inlet hose 51 of the cold water control valve 50, and the water inlet hose 61 of the hot water control valve 60 respectively, thereby forming a multi-part faucet structure that may be assembled in a separating manner.

Accordingly, in the switch valve mounting device of a faucet in accordance with the present invention, the switch valve 20 may be mounted in the four-way valve body 10 individually and independently, so as to replace the conventional faucet body that is integrally made, so that mounting of the switch valve 20 is not limited by the configuration and space of the faucet body, thereby simplifying the type and size of the switch valve 20, so that the switch valve 20 of a single type and size is available for faucets of different types and sizes. In addition, by the separating assembly manner, the four-way valve body 10 may co-operate with parts or accessories of different types, so that the four-way valve body 10 is available for a sink, a lavatory, a bath tub or the like, thereby enhancing the versatility of the switch valve mounting device of a faucet in accordance with the present invention.

In conclusion, in the switch valve mounting device of a faucet in accordance with the present invention, the structure of the faucet adopts a separating design. In such a manner, the four-way valve body is used to replace the conventional faucet body that is integrally made, so that mounting of the switch valve is not limited by the configuration and space of the faucet body. In addition, by the separating assembly manner, the four-way valve body may co-operate with parts or accessories of different types, thereby enhancing the versatility of the switch valve mounting device of a faucet in accordance with the present invention.

Although the invention has been explained in relation to its preferred embodiment as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A switch valve mounting device of a faucet, comprising a four-way valve body, and a switch valve mounted in the four-way valve body, wherein:
the four-way valve body has an inner wall formed with an inner space for mounting the switch valve;
the four-way valve body has a first portion provided with a first tubular section for connection to a water outlet head, and a second portion provided with a second tubular section which is formed with an outer thread for connection to a spray hose of a spray head; and
the four-way valve body has an outer wall provided with a third tubular section for connection to a water inlet hose of a cold water control valve, and provided with a fourth tubular section for connection to a water inlet hose of a hot water control valve.

2. The switch valve mounting device of a faucet in accordance with claim 1, wherein the first tubular section of the four-way valve body is formed with an inner thread.

3. The switch valve mounting device of a faucet in accordance with claim 1, wherein the second tubular section of the four-way valve body is formed with an outer thread.

4. The switch valve mounting device of a faucet in accordance with claim 1, wherein the second tubular section of the four-way valve body has a reduced diameter.

5. The switch valve mounting device of a faucet in accordance with claim 1, wherein the third tubular section of the four-way valve body is formed with an outer thread.

6. The switch valve mounting device of a faucet in accordance with claim 1, wherein the fourth tubular section of the four-way valve body is formed with an outer thread.

7. The switch valve mounting device of a faucet in accordance with claim 1, wherein the third tubular section of the four-way valve body is formed with a water inlet hole communicating with the inner space of the four-way valve body.

8. The switch valve mounting device of a faucet in accordance with claim 1, wherein the fourth tubular section of the four-way valve body is formed with a water inlet hole communicating with the inner space of the four-way valve body.

9. The switch valve mounting device of a faucet in accordance with claim 1, wherein the inner space of the four-way valve body has an inner edge formed with an annular insertion groove for securing the switch valve in the inner space of the four-way valve body by a C-shaped snap ring.

10. The switch valve mounting device of a faucet in accordance with claim 1, wherein the switch valve is mounted in the inner space of the four-way valve body individually and independently.
